(19) United States
(12) Patent Application Publication
(10) Pub. No.: US 2007/0190215 A1
(43) Pub. Date: Aug. 16, 2007

(54) Method of making a pizza crust

(76) Inventor: Sail Katta Reddy, Urbana, IL (US)

Correspondence Address: SAIL KATTA REDDY, P.O. BOX 551, URBANA, IL, 61803, US

(21) Appl. No.: 11/354,442

(22) Filed: Feb. 15, 2006

(51) Int. Cl. A21D 10/00

(52) U.S. Cl. 426/549

(57) ABSTRACT

A method of making a pizza crust or the like by grinding pre-soaked par-boiled rice and pre-soaked beans (black gram) in the ratio of 3:1 Setting aside the mixture for about 12 hours under warm temperature for fermentation process to take place, pouring the fermented batter in a pizza pan and oven baking the batter until a dry, delicious, delicate golden brown crust has been formed. Turning the crust upside down and placing it on the pizza screen, applying sauce and toppings along with cheese and baking in the oven until the pizza is ready to consume.

### CROSS REFERENCE TO RELATED APPLICATIONS

Not Applicable

### STATEMENT REGARDING FEDERALLY SPONSORED RESEARCH AND DEVELOPMENT

Not Applicable

### FIELD OF INVENTION

A method of this invention relates to a unique process of creating a pizza crust or the like.

### BACKGROUND OF THE INVENTION

Pizza is probably the most globally recognized food today. Originally a food for the poor, it is now a dish for everyone. It is truly the result of a transformation developed over the centuries.

There are very many methods of making a pizza crust from scratch. Some use wheat flour, some use bran flour, some use soy flour, some use all purpose flour, some use corn flour along with yeast, salt, sugar, eggs, milk and some water. One has to mix the flour along with other ingredients to make it into a dough ball. Then the dough is flattened by hand tossing method or by passing the dough ball through the dough rollers to flatten the dough ball in order to make a desired size and shape of a pizza crust. Tedious process is involved in preparing the dough from scratch.

A recipe from India, where one uses par-boiled Rice & Beans (Urad dal or Black Gram) in the ratio of 3:1. Rinse and soak the above mixture in water for about 2-3 hours. Then grind the mixture in a blender with addition of water in steps. Salt added and kept aside under certain temperature for about 12 hours. This recipe is used even now from centuries and centuries in INDIA to prepare Indian bread called IDLI. This bread is prepared by using the rice and beans and steam cooked in a pressure cooker. The end product is white, fluffy, and delicate bread.

The same recipe is used to make pancake like batter by adding more water and by grinding the mixture longer to prepare a dish called DOSAI in INDIA. The batter is spread on a hot frying pan to create a very paper thin and crispy food.

Using the same batter, UTTAPAMS are made by mixing onions and vegetables in the batter and frying the batter until the batter gets dry and pancake like food is formed.

To conclude the recipe that is used to create IDLI can be used to create a golden brown, delicious, delicate pizza crust or the like can be produced by oven baking the batter.

### SUMMARY OF THE PRESENT INVENTION

1. It is an object of the invention to provide a method of making a pizza crust or the like involving less labor cost.

2. It is an object of the invention to provide a method of making pizza crust or the like using a mixture of rice and beans.

3. It is the further object of the invention to provide a method of making a pizza crust or the like involving oven baking the batter made of rice and beans to produce a crispy, golden brown and delicate crust or bread for a pizza crust or the like.

4. It is the further object of my invention where one can eat the crust in the form of a pizza crust or in the form of bread sticks.

### METHOD

1. Soaking par-boiled rice and beans (black gram stripped of their hull and split) for about 2-3 hours. The ratio of rice=3. The ratio of black gram=1.

2. Grinding the rice and beans mixture in a blender or stone grinder (adding water in steps).

3. Adding required amount of salt to cut down the sour taste of the batter and to give a likeable taste to the batter.

4. Setting the mixture to get sour under warm temperatures (Fermentation process takes place) for 12 hours.
Or

Buying the instant IDLI mix already processed mixture of rice and beans and adding adequate water in the powder to make the batter.

5. Further step involving spraying oil on to the non-stick pizza pans and spreading the batter evenly into the pan. The pan must have an edge so that the batter won't run away from the pan. The size of the pan and the height of the edge of the pan depending on the thickness of the crust desired.

6. Further step involving baking the batter in the oven until the top of the crust turns dry and overall forming a golden brown, crispy crust for a pizza base and the like.

7. Further step involving removing the crust from the pan and turning the crust upside down and placing carefully on to a pizza screen to prepare a desired pizza for consumption.

8. Further step involving applying sauce to the top of the pizza crust and adding desired toppings evenly and baking the pizza crust until the top and the bottom crust and the toppings are baked.

Preparing the crust ahead of time and freezing them carefully as the crust can become brittle saves a lot of time is one way of having the cooked crust ready.

While the method has been described in connection with what is considered the most practical and preferred method, it is to be understood that the methods are not limited to the disclosed; but on the contrary intended to cover various modifications, such as changes in size, shape and thickness, rearrangement of steps involved in the process of making the pizza crust or the like.

1. A method of making a pizza crust or the like comprising:
a) Soaking par-boiled rice and soaking hulled and split black gram wherein the ratio of rice being 3 and the ratio of beans being 1.
b) Grinding in a blender or stone grinder.
c) Adding required amount of salt and water to cut down the sour taste of the batter.
d) Setting the mixture aside for fermentation process to take place for 12 hours under warm temperatures.
e) Spraying oil on to the non-stick pan before pouring the batter in it.
f) Baking the batter in the oven until the top of the crust or the like is golden brown and dry.
g) Removing the crust from the pan and turning the pizza crust upside down and placing the crust on a pizza screen carefully.
h) Applying sauce and desired toppings on the top of the crust and baking the crust once again until the top of the toppings are baked properly.
